(19) United States
(12) Patent Application Publication
(10) Pub. No.: US 2009/0045380 A1
(43) Pub. Date: Feb. 19, 2009

(54) Lift stand

(76) Inventor: Mark Aiken, Brentwood, CA (US)

Correspondence Address: DERGOSITS & NOAH LLP, FOUR EMBARCADERO CENTER, SUITE 1450, SAN FRANCISCO, CA, 94111, US

(21) Appl. No.: 11/891,757

(22) Filed: Aug. 13, 2007

(51) Int. Cl. B66F 3/00

(52) U.S. Cl. 254/131

(57) ABSTRACT

A motorcycle lift stand has a lifting surface, a base with legs and a center post having an internal gas compression spring and locking mechanism. The locking mechanism is coupled to a touch pad that is attached one of the legs of the base. In use, a motorcycle is placed on the lifting surface and the touch pad is actuated causing the gas spring to apply an upward force on the motorcycle. With the assistance of the lift stand the user can raise the motorcycle to the desired height. When the motorcycle is property positioned, the user releases the touch pad to lock the lift stand to the desired height. The lift stand is lowered by actuating the touch pad. An internal dampening mechanism slows the downward movement of the motorcycle.

### FIELD OF THE INVENTION

The present invention relates to the field of vehicle maintenance accessories. More specifically, the present invention relates to a new adjustable lift stand.

### BACKGROUND OF THE INVENTION

Existing lifts stands are used as accessories in vehicle maintenance shops. These lift stands can be used for lighter motorcycles. During use, the motorcycle is placed on the lift stand with the bottom center secured to the lift surface. The lift surface is raised and the motorcycle is lifted from the shop floor. The user can then work on the motorcycle in the elevated position.

Prior lift stands use a mechanical multi joint lever mechanism to raise and lower the lift platform. The joint lever mechanism typically requires the user to depress a lever arm that is coupled to a linkage that raises the motorcycle and lift surface. The user may step on a pedal in order to actuate the mechanical lever. The joint lever mechanism may have a mechanical lever with a balanced force to distance ratio. For example, the lever ratio may be 4 to 1, meaning that the lift force will be 4 times the force applied to the pedal by the user. For example, if the motorcycle weighs 400 lbs, a 150 lbs force on the pedal may be required to actuate the joint lever mechanism.

The travel of the pedal may also be proportional to the travel of the lift surface based upon the equation force×distance=constant. Thus, if the movement of the lift surface is 3 inches, the lift force is 400 lbs and the pedal force is 100 lbs, the movement of the pedal is 12 inches. (400 lbs×3 inches)/100 lbs=12 inches. This assumes perfect mechanical efficiency. In actual use some of the force applied to the mechanism will be lost due to friction and more user force will be required.

The joint lever mechanism may only lock in place once the lift surface is fully raised. Thus, until the lift surface is fully raised, the user must apply the fully force required to lift the motorcycle. Because a large force is required to move the lever the lift stand can be dangerous to the user and motorcycle if the user releases the lift force prematurely. These forces also make it difficult for lightweight users who may have difficulty applying all of the weight to the lever mechanism. Yet another problem with the joint lever mechanism is that once it is fully depressed, the lever may extend away from the stand creating a tripping hazard. If the lever is accidentally kicked, the pedal can fly up and the lift stand can drop the motorcycle quickly possibly resulting in damage to the user and motorcycle.

Lower the lift stand may also be problematic. The two most common ways to lower the lift stand are to either hold up the motorcycle steady on the stand and simultaneously pull up on the joint lever with a foot or alternatively use a separate release lever to release the joint lever mechanism. As the lift surface drops, the user must instantly release the motorcycle. Because there are no mechanisms to slow the motorcycle has it drops, the lift surface quickly drops the motorcycle to the ground. Accordingly, what is needed is a lift stand that is both safer and easier to use.

### SUMMARY OF THE INVENTION

The present invention is an improved lift stand that can be used for motorcycles or other heavy objects. The inventive stand include a lifting platform, a base and a lift column having a compression spring with a locking mechanism and a movement dampening mechanism mounted between the platform and base. The lifting platform can be a planar surface and the base can include a plurality of legs that extend radially outward and provide stability to the stand. The locking mechanism can be controlled by a touch pad is placed on an end of one or more of the legs.

The inventive lift stand operates in a substantially different manner than prior lift stands that use a lever mechanism to lift the motorcycle to a predetermined set height. As discussed in the background, the prior art lift stands require a high force against the pedal to lift the motorcycle and once raised, the pedal can be easily released by accident, which results in the pedal quickly moving up with high force and the motorcycle being dropped to the ground. The speed and force of the pedal can strike a user and cause injury.

In contrast, in an embodiment the inventive lift stand provides most of the lifting force and the user provides additional force to raise the motorcycle to the desired height. The user can lock the inventive lift stand in place at any desired height rather than being limited to a single height setting. The inventive lift stand is also safer because it conceals all high load bearing and moving parts within the stand structure. The inventive lift stand also has a dampening mechanism that slows the downward movement so the motorcycle is gently lowered to the ground reducing the risk of injury to both the user and the motorcycle. The dampening feature is also much safer because if the locking mechanism is accidentally released the motorcycle is slowly lowered rather than being dropped and the release will not cause any components to move with a high speed that can injure the user.

The compression spring within the lift column is preferably a pressurized gas spring, however in other embodiments, mechanical springs or hydraulic cylinders can be used. The gas spring may include a rod and a piston mounted within a bore of a cylinder. The piston has a gas tight seal that slides against the inner surface of the cylinder bore so that pressurized gas is trapped between the piston and the bore. A rod is coupled to the piston and exits from one end of the gas spring. In the relaxed state, the rod is fully extended from the gas spring and the lift stand is fully raised. If the downward force on the spring exceeds the expansion force, the spring will be compressed.

A locking mechanism is coupled to the gas spring and allows the spring to be locked so the rod extension can be locked to any extension length regardless of the force that is applied to the lift stand. The compressed gas allows the piston to excerpt a force and causes the height of the lift column to be locked at any extension position. In a simple gas spring, the space within the cylinder on the opposite side of the compressed gas volume is free to flow in and out of the cylinder as the piston moves. However, this space can be used to prevent the movement of the piston and function as a locking mechanism. In an embodiment, the locking mechanism includes fluid and a valve that prevents fluid from moving within the cylinder. The valve can prevent gas from flowing out of the cylinder thus restricting the movement of the piston.

Alternatively, the gas spring can contain both a compressible gas and an incompressible hydraulic fluid. By controlling the flow of the hydraulic fluid through a valve in the piston within the cylinder, the piston can be opened to allow movement or locked in to prevent the rod from moving. Because the hydraulic fluid is incompressible, a gas spring with a hydraulic locking mechanism is more securely locked in place than a gas spring that only uses a gas locking mechanism.

The gas spring can also include a dampening mechanism that controls the rate of movement of the rod relative to the gas spring. This is particularly helpful when lowering a motorcycle placed on an extended lift stand. When the user wishes to lower the motorcycle, the touch pad can be attached to a leg extending outward from the base of the lift stand. This placement of the touch pad moves the control of the lift stand away from the moving parts so the user will not have any limbs under the lift stand when it is lowered. The touch pad is actuated to release the locking mechanism and the dampening mechanism allows the motorcycle to be slowly lowered to the ground.

In an embodiment, the locking mechanism may be a hydraulic system that is built into the piston of the gas spring and coupled to the rod extending from the spring to the base of the lift stand. The cylinder may include a lower gas portion and an upper hydraulic fluid portion that are separated by a separating piston that is free to travel within the cylinder and positioned below the piston that is coupled to rod that extends from the cylinder. The locking system may include a hydraulic valve that is built into the piston that controls the flow of hydraulic fluid through the piston within the cylinder. When the hydraulic valve is closed, the gas spring is locked and the rod extending from the cylinder cannot be compressed into the gas spring. When the hydraulic valve is open, the gas spring is free to move and the internal gas pressure causes the gas spring to expand with the rod extending from cylinder. In an embodiment, the rod may have a center bore running the length of the rod and the hydraulic valve can be coupled to a shaft mounted within the bore of the rod. The shaft allows the user to control the valve and the locking mechanism by actuating the shaft.

The hydraulic valve and shaft can be coupled to an actuator that is controlled by a touch pad on one or more of the legs of the base. This configuration allows the user to free the lift stand so that the position of the gas spring can be adjusted by stepping on the touch pad. To raise the motorcycle, the user can disengage the locking mechanism by stepping on the touch pad while applying an upward force with the expansion force of the spring to lift the motorcycle. At the desired position, the user can release the touch pad to lock the lift stand at the desired height. To lower the motorcycle, the user can simply deactivate the locking mechanism, the weight of the motorcycle will be greater than the expansion force of the spring and the motorcycle will be lowered to the ground.

In an embodiment, the gas spring is set for 150 pounds of force. The lift column is in the lowered position and a 200 pound motorcycle is placed on top of the lifting platform and secured in place. When the touch pad is depressed, the locking mechanism is deactivated which allows the height of the lifting platform to be adjusted. The plat form rises to the bottom surface of the motorcycle and stops. Since the gas spring excerpts 150 pounds and the motorcycle weights 200 pounds, the additional lifting force is 50 pounds which is supplied by the user. When the desired or maximum height is reached, the user releases the touch pad to lock the height of the lifting platform. The user can now work on the motorcycle with the wheels raised off the ground.

To lower the motorcycle, the user actuates the touch pad to release the locking mechanism and the weight of the motorcycle overcomes the gas spring force and the lift column lowers. Once the wheels of the motorcycle contact the ground, the motorcycle can be removed from the lift stand. To further lower the lifting surface from the motorcycle, the user can apply a force greater than 150 lbs. while actuating the touch pad. If the user weights more than 150 lbs, his or her body weight can be used to lower the lifting surface. In other embodiments, the expansion force may be greater than or equal to the weight of the motorcycle and the user may have to apply a downward force to lower the motorcycle.

These and other advantages and features of the invention will become readily apparent to those skilled in the art after reading the following detailed description of the invention and studying the accompanying drawings.

### BRIEF DESCRIPTION OF THE DRAWINGS

Embodiments of the inventive apparatus will be described in more detail with reference to the accompanying drawings in which:

FIG. 1 is a perspective view of an embodiment of the motorcycle lift stand in the extended position;

FIG. 2 is a perspective view of an embodiment of the motorcycle lift stand in the compressed position;

FIG. 3 is a sectional side sectional view of an embodiment of the motorcycle lift stand;

FIG. 4 is a sectional side sectional view of an embodiment of the motorcycle lift stand;

FIG. 5 is a sectional side sectional view of an embodiment of the motorcycle lift stand; and

FIG. 6 is a sectional side view of an embodiment of the gas spring.

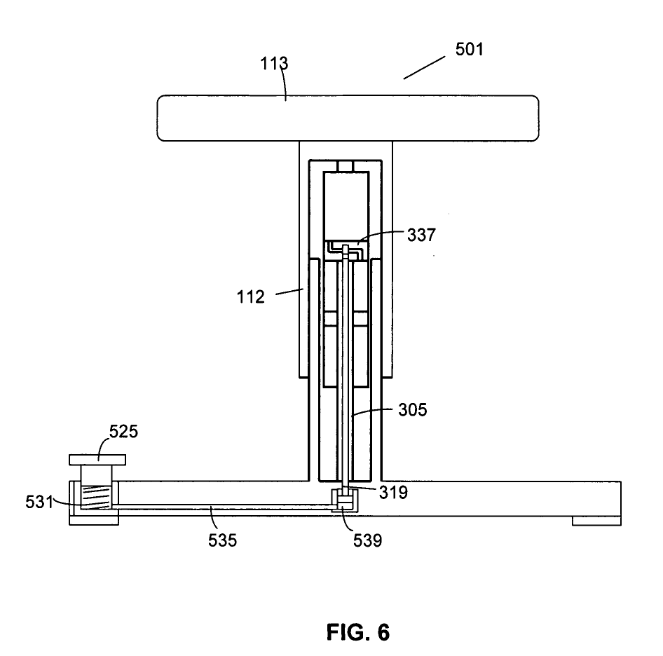

### DETAILED DESCRIPTION

The following is a detailed description of the presently preferred embodiments of the present motorcycle stand and motorcycle trailer invention. However, the present invention is in no way intended to be limited to the embodiments discussed below or shown in the drawings. Rather, the description and the drawings are merely illustrative of the presently preferred embodiments of the invention.

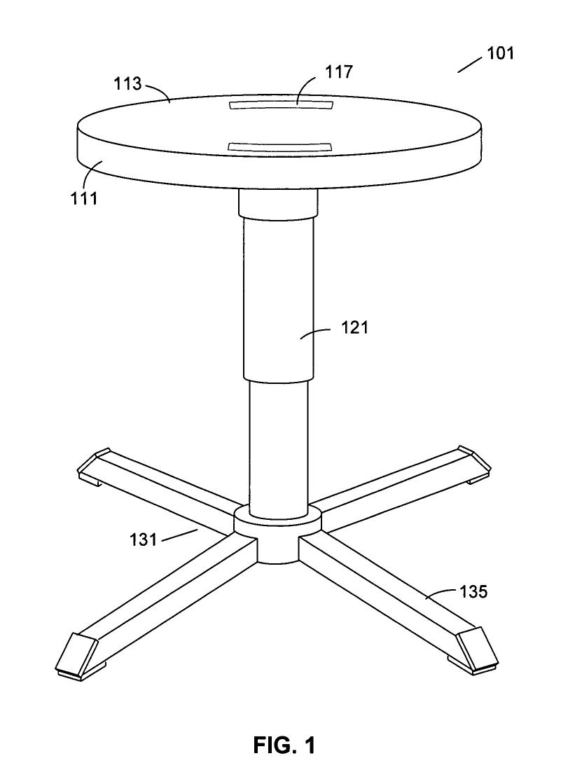

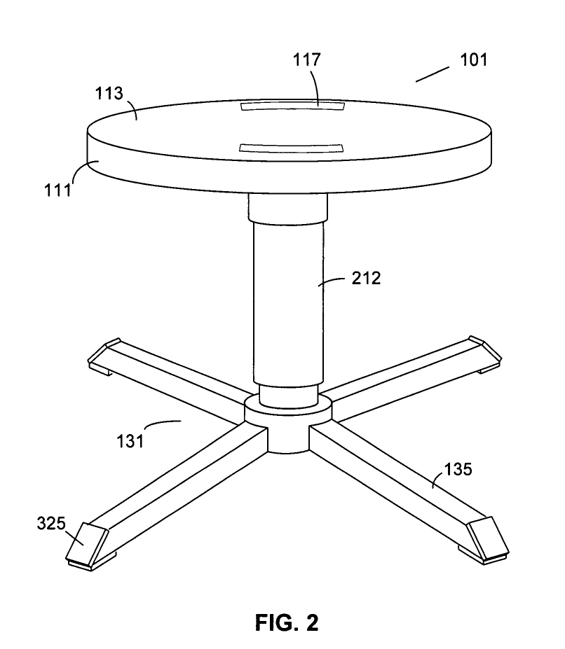

The inventive lift stand 101 is illustrated in the extended position in FIG. 1 and in the compressed position in FIG. 2. The lift stand 101 includes a lift platform 111, an adjustable column 121 and a base 131. In an embodiment, the lift platform 111 has a circular planar lift surface 113. The upper surface of the lift surface 113 can be padded to protect the motorcycle that is being lifted by the lift stand 101. In other embodiments, the lift surface 113 can be rectangular or any other shape. The lift surface 113 may also be planar or in other embodiments, contoured to a shape corresponding to the bottom of a specific motorcycle.

When a motorcycle is lifted, it should be secured to the lift surface 113 to prevent the motorcycle from falling over. The motorcycle can be secured to the lift surface 113 with straps, clamps, couplings or any other connecting device that will off of the lift stand 101. In order to help secure the motorcycle, the lift platform 111 may include holes, slots or other types of attachment points 117 that can be positioned around the edge of the lift platform 111. For example, straps can be passed through the holes 117 and around the motorcycle to secure the motorcycle, to the stand 101. The strap may have a buckle that allows the strap to be securely tightened. In other embodiments, the lift platform 111 may have threaded holes or rods that allow the motorcycle to be temporarily secured to the lift stand with threaded fasteners. In yet another embodiment, the edge of the lift surface 113 may have a lip that functions as a lip to securely hold hooks attached to the straps or clamps that can grip the motorcycle frame but not damage the finish.

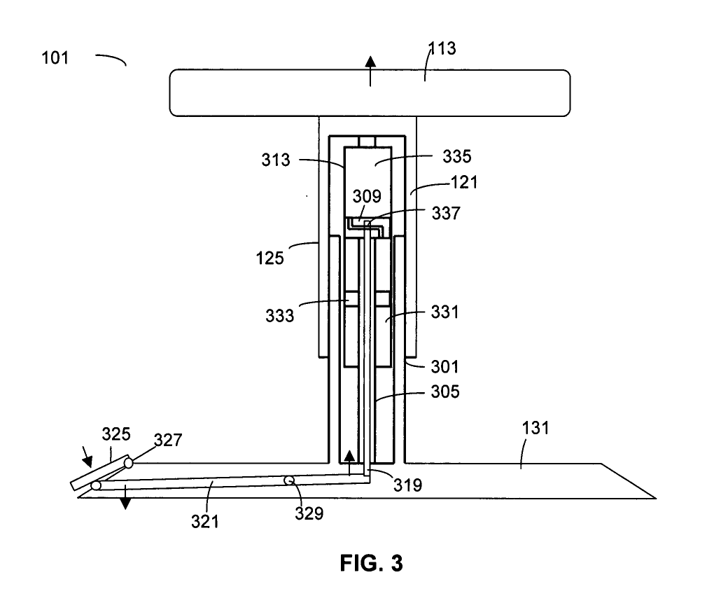

With reference to FIG. 3, in an embodiment the adjustable column 121 is an elongated member that has an upper tube 125 and a lower tube 127. The upper tube 125 is coupled to the lifting surface 113 and the lower tube 127 is coupled to the base 131. The upper tube 125 and lower tube 127 have different diameters and are arranged to slide within each other concentrically. In this embodiment, the upper tube 125 has a larger diameter than the lower tube 127. In an embodiment, the spring 301 is housed within the hollow column 121. In addition to providing a housing for the spring, the column may also provide stability to the lift platform. In an embodiment, the inner diameter of the upper tube 125 is just slightly larger than the outer diameter of the lower tube 127 and even in the fully extended position, there is a substantial amount of over lap between the upper tube 125 and the lower tube 127. This configuration prevents the top tube 125 from deflecting out of vertical alignment when a load is unevenly distributed on the lift surface 113.

Another method for maintaining the vertical alignment of the components is to use bushings attached to the upper tube 125 and lower tube 127 that allow them to move axially relative to each other but not move out of alignment. More specifically, in an embodiment a first annular bushing is mounted on the lower surface of the upper tube 125 that slides against the outer diameter of the lower tube 127. A second annular bushing can be mounted on the upper surface of the lower tube 127 that slides against the inner diameter of the upper tube 125. The upper tube 125 and lower tube 127 are preferably made of a strong material such as aluminum, steel, carbon fiber composite or other structural materials. The bushings are preferably made of a smooth sliding plastic such as Teflon, Delrin, Torlon, a strong porous material impregnated with a smooth sliding polymer or other similar materials. Although the lower tube 127 is described as a tube, in an embodiment, it can be a solid rod. In the preferred embodiment the upper tube 125 and the lower tube 127 are circular in cross section, however in other embodiments, the cross section can be any other geometric shape: triangular, rectangular, oval, etc.

In an embodiment, the base 131 has a plurality of legs 135 that are coupled to the bottom of the lower tube 127. The legs 135 extend away from the lower tube 127 in a radial pattern and provide stability to the lift stand 101. The illustrated embodiment has four legs 135 but in other embodiments, there can be three or more legs or alternatively the legs may be replaced by a plate such as a circular plate or a conical member that provides a large stable surface. In the preferred embodiments, the outer ends of the base 131 extend farther from the center post than the lifting platform 111.

With reference to FIG. 3 a cross sectional view of the lift stand is illustrated. This provides a view of a gas spring 301 that is mounted within the upper tube 125 and the lower tube 123. The gas spring 301 is an energy-storage device similar in function to mechanical coil spring. The gas spring 301 uses internal gas pressure to expand the spring 301 which helps to raise the motorcycle. The gas spring 301 includes a shaft 305 and a piston 309 that travel within a cylinder 313. In this embodiment, in the relaxed state the rod 305 extends out of the bottom of the cylinder 313 as the gas spring 301 expands. Conversely, if a compressive force exceeds the spring force, the rod 305 is pressed into the cylinder 313 and the spring 301 is compressed.

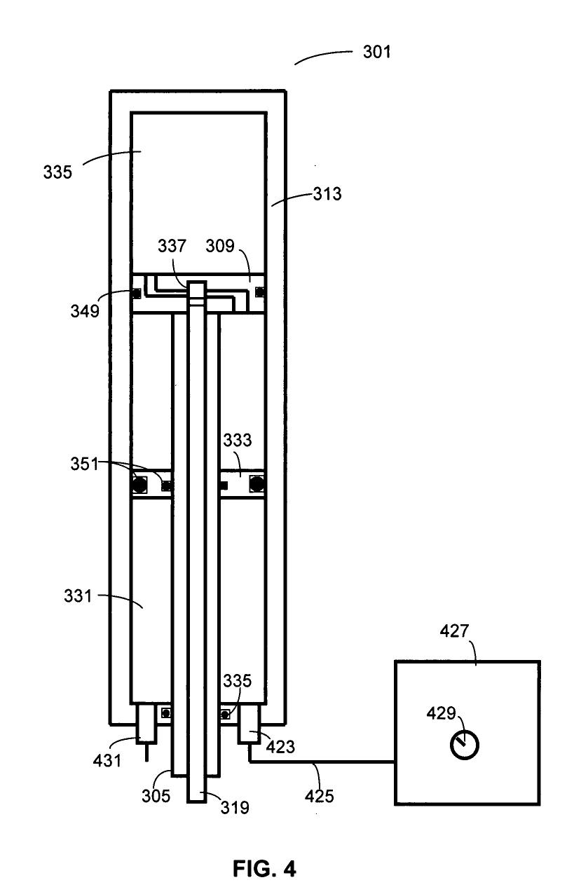

A more detailed cross sectional view of a gas spring 301 component of the lift stand 101 is illustrated in FIG. 4. In the illustrated embodiment, the gas spring 301 includes a cylinder 313 that contains a compressed gas 331 and hydraulic fluid 335. The gas 331 and hydraulic fluid 335 are separated by a separating piston 333 that forms a seal 351 against the inner diameter of the cylinder 313 and the rod 305 that extends from the gas spring 301. A seal 349 is also placed between the outer diameter of the piston 309 and the inner diameter of the cylinder 313. There is also a gas seal 355 at the area of the cylinder 313 where the rod 305 exits the gas spring 301. In an embodiment, the seals 349, 351, 355 are O-rings or any other type of sliding fluid sealing device such as x-rings and spring energized seals. In an embodiment, the seals are lubricated to minimize the sliding friction of the piston 309, rod 305, and separating piston 333 within the cylinder 313. The compression of the seals 349, 351, 355 between the sliding components prevents fluids from flowing around the seals 349, 351, 355 but also results in friction between the sliding components which reduces the mechanical efficiency of the gas spring 301.

The internal pressure of the gas 331 presses against the separating piston 333 as it tries to expand as much as possible. If the piston valve 337 is open, the movement of the separating piston 333 towards the hydraulic fluid 335 causes the piston 309 to move down so that the rod 305 extends from the cylinder 313. Since the hydraulic fluid 335 is incompressible, the only movement that will expand the interior volume of the cylinder 313 is to remove the rod 305 from the cylinder 313. Without any compression loading, the piston 309 may move down until it contacts the separating piston 333. When the rod 305 is pressed into the cylinder 313 by a force that exceeds the expansion force of the spring, the rod 305 consumes volume within the cylinder 313 which results in compression of the gas 331 but not the hydraulic fluid 335. More specifically, the piston 309 will move up and the separating piston 333 will move down further compressing the gas 331.

The gas spring 301 includes a locking mechanism that prevents the movement of the shaft 305 in any position relative to the cylinder 313. In an embodiment, the locking mechanism is a valve 337 that is coupled to the piston 309 within the gas spring. The valve 337 allows the hydraulic fluid 335 to flow from one side of the piston 309 to the other side. When the valve 337 is open, the piston 309 and rod 305 can move within the cylinder 313. When valve 337 is closed, the piston 309 and rod 305 are locked in place within the cylinder 313. The locking mechanism can be coupled to an elongated shaft 315 that extends through the rod 305. The rod 305 can apply a force to the lower tube 127 but since the shaft 315 is used to control the valve 337, it should be isolated and separated from any lifting or compression forces produced by the gas spring 301.

With reference to FIG. 3, in addition to providing the locking feature, the valve 337 of the locking mechanism can also be used to provide dampening of the movement of the lift stand 101. The rate of expansion or contraction of the gas spring 301 can be controlled by the flow of hydraulic fluid through the valve 337 in the piston 309. The size of the orifice in the valve 337 controls the flow rate of the hydraulic fluid 335. With a large orifice, the hydraulic fluid 335 can travel very quickly through the piston 309 resulting a faster movement of the rod 305 within the cylinder 313 and a faster change of the lift stand 101 height. Conversely, with a smaller orifice, the hydraulic fluid 335 flow is restricted and the rod 305 will travel more slowly resulting in a slower change in height. In an embodiment, the internal valve 337 has a variable sized orifice which allows the user to control the amount of dampening of the lift stand 101. By fully depressing the touch pad 325, the valve 337 orifice is fully open and actuating the, the stand 101 will quickly lower a motorcycle and by partially actuating the valve 337, the stand will lower the motorcycle more slowly. In the preferred embodiment, the maximum valve 337 orifice should be sized so that the maximum rate of travel is not more than a couple of inches per second with the weight of a heavy motorcycle.

In an embodiment, the shaft 315 that controls the locking mechanism valve 337 is coupled to an arm 321 that extends through one of the legs 135 to a touch pad 325 mounted at the end of the leg 135. When the user steps on the touch pad 325, the presses down on the arm 321 which rotates about a pivot point 329. The opposite end to the arm 321 engages the shaft 319 that extends from the rod 305. The touch pad 325 can be plate or any other structure that is actuated by the user's foot. When the user wishes to adjust the height of the motorcycle, he or she steps on the touch pad 325 which causes the arm 321 to press the shaft 319 into the rod 305. The shaft 319 releases the locking mechanism 309 and allows the rod 305 and piston 309 to move within the cylinder 313. The placement of the touch pad 325 that controls the locking mechanism 221 is preferably away from the center column 121 and provides improved safety since the user can control the lift stand 101 while standing away from the moving parts.

In addition to providing the height locking feature, the valve 337 of the locking mechanism can also be used to provide dampening of the movement of the lift stand 101. The rate of expansion or contraction of the gas spring 301 can be controlled by the flow of hydraulic fluid through the valve 337 in the piston. The size of the orifice in the valve 337 controls the flow rate of the hydraulic fluid 335. With a large orifice, the hydraulic fluid can travel very quickly through the piston 309 resulting a faster movement of the rod 305 within the cylinder 313 resulting in a faster raising or lowering of the lift stand 101. Conversely, with a smaller orifice, the hydraulic fluid 335 flow is restricted and the rod 305 will travel more slowly resulting in a slower raising or lowering of the lift stand 101.

In an embodiment, the internal valve 337 has a variable sized orifice which allows the user can control the dampening of the lift stand 101. The user has the option of fully actuating the touchpad 325 and valve 337 so that the lift stand 101 will lower a motorcycle quickly. Alternatively, the user can partially actuate the touchpad 325 and valve 337, so the rate of travel of the lift stand 101 can be controlled to move more slowly. In the preferred embodiment, the maximum valve 337 orifice should be sized so that the maximum rate of travel is not more than a couple of inches per second with a heavy motorcycle.

There are various possible mechanisms that allow the touch pad 325 to actuate the shaft 315. In one embodiment illustrated in FIG. 3, the touch pad 325 is coupled to a hinge 327 on the leg 135. When the touch pad 325 is depressed, the extended end 331 of the arm 321 is pressed down. The arm 321 is coupled to a pivot point 323 which causes the central end 333 of the arm 321 to press the shaft 315 into the rod 305 to open the valve 337. The valve 337 may have a spring that normally keeps the valve 337 in the closed position.

In this embodiment, the touch pad 425 is fastened to the end of the arm 421 so there is no need for a hinge coupled to the touch pad 425. Depressing the touch pad 425 causes the arm 421 to rotate about the pivot 429 and presses an end of the arm 421 into the shaft 319 which controls the valve 337 of the locking mechanism. Although it is aesthetically desirable to have the arm fully contained within the leg, it is also possible to have the arm 421 fully or partially exposed on a portion of the leg 435 as shown in FIG. 4.

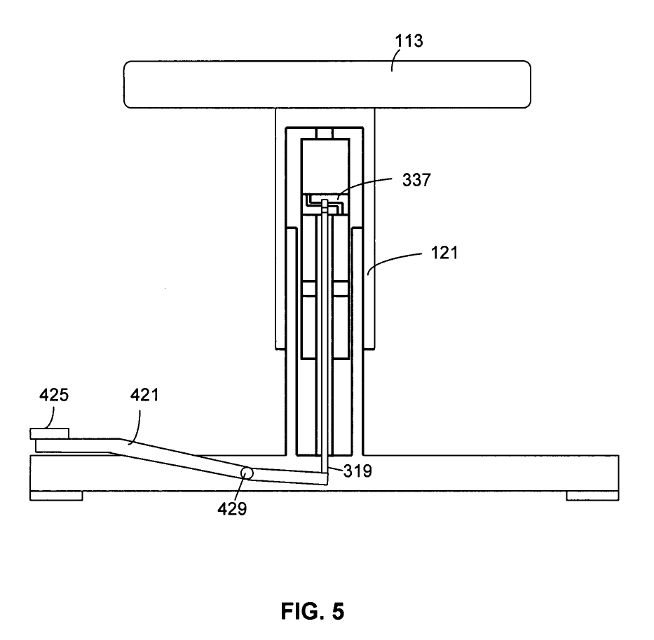

In addition to lever arms, various other mechanisms can be used to actuate the shaft 319. With reference to FIG. 5, in an embodiment, a hydraulic or pneumatic system is used to actuate the shaft 319. In these embodiments, the touch pad 525 is coupled to a pressure cylinder 531 that may be spring loaded so that the touch pad 525 is normally raised. The pressure cylinder 531 is filled with a fluid such as hydraulic fluid or a gas such as nitrogen. Then the touch pad 525 is pressed, the cylinder 531 is compressed and pressurizes the fluid which flows through a hose 535 to an actuator 539. The actuator 539 responds to the increased fluid pressure by moving the shaft 319 up within the rod 305 releases the locking mechanism 337 by opening the valve and allowing the height of the lift stand 501 to be adjusted. When the user releases the touch pad, 525, an internal spring draws the hydraulic or pneumatic fluid back into the cylinder 531 which causes the actuator to lower the shaft 319. With the shaft 319 in the lower position, the valve is closed and the locking mechanism 337 is engaged causing the lifting surface 513 of the lift stand 501 to be locked into a set height.

The expansion force produced by the gas spring 301 is related to the internal pressure multiplied by the effective area of the rod. The expansion force is equal to the gas pressure multiplied by the cross sectional area of the rod 305, force=pressure/area. Thus, if the rod 305 has a cross sectional area of two square inches, the internal pressure needs to be 75 pounds per square inch for an expansion force of 150 pounds. As the compressed gas volume expands and the piston 309 moves down within the cylinder 313, the internal pressure will decrease based upon the equation pressure×volume=constant. For simplicity, the following calculations will use a constant rather than a variable expansion force. Further these calculations do not account for friction forces that can also reduce the mechanical efficiency of the gas spring.

With reference to FIG. 4 again, in an embodiment the gas spring 301 can have a valve 423 that allows the internal pressure of the pneumatic gas 331 to be adjusted. In this embodiment, the valve 423 can be coupled to a pressurized gas source 427 with a hose 425 to increase the internal pressure of the gas spring 301. The pressurized gas source 427 can be a pump, high pressure gas reservoir or other gas pressure source. The gas source 427 or the cylinder 313 itself may have a pressure gage 427 that allows the user to monitor the pressure of the pneumatic gas 331. When the gas 331 is pressurized to the desired level user can close the valve 423 and remove the hose 425. This method allows the user to adjust the spring force of the gas spring 301 to match the weight of the motorcycle. In an embodiment, the valve 423 has a self sealing mechanism that automatically seals the valve 423 when the hose 425 is disconnected.

In another embodiment, the cylinder 313 may have a gas inlet valve 423 and a separate gas outlet valve 431. In this embodiment, the pressurized gas source 427 is coupled to the open inlet valve 423 with the outlet valve 431 closed. The gas flows into the cylinder 313 and the internal pressure of the compressed gas 331 rises. If the internal pressure of the compressed gas 331 exceeds the desired level, the inlet valve 423 is closed and the outlet valve 431 is opened to decrease the internal pressure of the gas 331. Once the internal pressure is properly adjusted, the outlet valve 431 is closed. In an embodiment, the outlet valve 431 is a low flow valve such as a needle valve.

Once the gas cylinder 301 is properly adjusted, it can be reinstalled in the center column 121 of the lift stand 101. In other embodiments, the internal pressure and spring rate of the gas spring 301 can be altered without having to remove the gas spring 301 from the center column 121. In these embodiments, the user can access the cylinder 313 of the gas spring 301 through the base 131 without any disassembly.

In yet another embodiment, the gas spring can be permanently sealed with a fixed quantity of gas. In the fixed quantity of gas embodiment, that there is no adjustability but would be suitable for motorcycles within a specific weight range. In a commercial embodiment, a store may stock the lift stands and separate gas springs in a variety of expansion forces. A buyer would then purchase the lift stand and the gas spring that is appropriate for the weight of the motorcycle.

In the preferred embodiment, the gas spring 301 is set to an expansion force less than the weight of the motorcycle. Thus, when the motorcycle is placed on the lowered lift stand 101 and the user steps on the touch pad 325, the lifting surface 113 of the lift stand 101 will raise up the bottom of the motorcycle and may relieve some of the weight from the suspension, but will not lift the motorcycle off the ground. The gas spring 301 expansion force alone does not lift the motorcycle. The motorcycle is raised by applying an additional upward force which may be provided by a manual lifting force to supplement the gas spring 301 expansion force.

The desired expansion force may depend upon the weight of the motorcycle. If the motorcycle weighs 200 pounds an equal amount of force must be applied to lift the motorcycle. If the lift stand 101 has an expansion force of 150 pounds, the user can apply an additional 50 pounds of lifting force to raise the motorcycle. If the motorcycle weighs 350 lbs, an expansion force of 150 pounds may be insufficient because the user will not be able to easily apply an additional upward force of 200 pounds to raise the motorcycle. With heavier motorcycles, it may be desirable to have a higher expansion force from the gas spring which would require a higher internal pressure.

With a properly adjusted gas spring 301, the user depresses the touch pad 325 and lifts the motorcycle to the desired height. At the desired height the user releases the touch pad 325 to lock the lift stand 101. The motorcycle can be worked on and after all the require work is completed, the user can lower the motorcycle by simply stepping on the touch pad 325 to release the locking mechanism. Without any additional lifting forces, the motorcycle is slowly lowered to the ground. As discussed, in an embodiment, the rate of movement of the lift stand 101 is controlled by the flow of hydraulic fluid through an orifice of the valve 337 in the piston 309 within the gas spring 301.

A problem with having high expansion force gas spring is that if the lift stand is fully expanded without any weight on the lift stand, it can be difficult to lower the lift stand so that it can be placed under a motorcycle. The user can place weights on the lift platform 111 until the expansion force is exceeded and then lower the lift stand 101. Alternatively, with reference to FIG. 4, if the gas spring 301 has a pressure relief valve 431, the valve 431 can be opened to reduce the expansion force so the lift stand 101 can be lowered. The relief valve 431 can then be closed and the gas spring 301 can be locked in place while gas is pumped into the spring 301 until the internal gas 331 is pressurized to the desired pressure.

The inventive lift stand may have additional adjustment features that help to make it more functional. In order to use the inventive lift stand, it is first placed under a center portion of the motorcycle. Thus, the height of the lift stand in the lowered position must be lower than the center portion of the motorcycle. In an embodiment, the height is adjustable so that the lowered height is just slightly less than the center height of the motorcycle. In an embodiment, adjusting the vertical length of the center column alters the height of the lift stand. The inventive stand may have a lowered height range of about 6 to 20 inches. The center height will depend upon the type of motorcycle, a dirt bike will have a higher center height while a street bike will have a much lower center height. The raised height of the inventive lift stand may range between 8 to 26 inches depending upon the lowered height and travel of the lift stand.

In an embodiment, the lowered height of the stand is controlled by a mechanical device within the center post above or below the gas spring. An example of the height adjustment device are spacers placed on top of or below the spring. By adding or removing these spacers or using the spacer that is the correct length, the lowered lift stand height can be adjusted. In other embodiments, the center post length can be adjusted with an adjustable length spring. For example, the cylinder or the length of the rod length can be adjustable through a screw mechanism so the user can adjust the length of the spring. The pieces might be screwed together to shorten the spring or screwed apart to lengthen the spring. These length adjustment mechanisms may include a locking device to prevent the spring from changing in length after is properly adjusted. Examples of locking devices include: a set screw, a lock nut or any other device that prevents movement of the length adjustment components.

The lift stand is used to get the motorcycle off the ground, so it may only require a relatively short lift travel of only a few inches, possibly 2 to 6 inches. The vertical travel range of the inventive lift stand will depend upon the design of the internal spring. As springs expand, the expansion force decreases. Thus, a fully compressed spring will produce a higher expansion force than an expanded spring. Because the vertical travel is fairly short, the expansion force might be fairly constant. Another method for reducing the variation in expansion force with rod travel is by using a large volume cylinder with a small piston. This configuration will minimize the change in volume of the cylinder throughout the vertical travel of the lifting surface so the expansion force remains fairly constant.

The lifting surface of the can be a circle or a rectangular plate or any other shape. The dimensions of the lifting surface should be large enough to securely support the motorcycle. An example of a suitable lifting surface is a circle having a diameter of 4 to 12 inches or a rectangle that has a length of 6 to 14 inches and a width of 4 to 10 inches. In order to provide a stable platform, the base should have larger dimensions than the lifting surface. For example, the base may have four legs that extend radially between from 10 to 20 inches or more from the base center.

The locking mechanism is preferably a hydraulic device in the gas cylinder that has been described above, but in other embodiments, the locking mechanism can also be a different mechanical device. For example, the touch pad may be coupled to an arm that actuates a pin mounted in the upper tube that releasable engages one or more holes in the lower tube. In the released position, the pin coupled to the upper tube is removed from the hole in the lower tube and in the locked position, the pin is inserted into one or more of the holes. The holes may be aligned vertically and spaced close together so that small adjustments in height can be made. Various other locking mechanisms can be used with the inventive lift stand.

While the present invention has been described in terms of a preferred embodiment above, those skilled in the art will readily appreciate that numerous modifications, substitutions and additions may be made to the disclosed embodiment without departing from the spirit and scope of the present invention. For example, in an embodiment the inventive lift stand may be used for a vehicle other than a motorcycle such as a three for four wheeled all terrain vehicle (ATV). In other embodiments, the internal spring mechanism may include a mechanical spring such as a coil or elastomer spring in combination with the gas spring or without the gas spring. If a mechanical spring is used, the described cylinder may only contain hydraulic fluid so that it only functions as a locking and dampening mechanism but not a gas spring. In these embodiments, the alternative springs are elongated members that can be placed in or around a center post between the base and lift platform. It is intended that all such modifications, substitutions and additions fall within the scope of the present invention that is best defined by the claims below.

1. A lift stand comprising
a lift platform adapted for supporting a motorized vehicle;
a base that is placed on a surface for providing stability to the lift stand;
an adjustable column disposed between the lift platform and the base, the adjustable column having a gas spring that includes a piston that slides against an inner diameter of a cylinder and a locking mechanism that slides against the inner diameter of the cylinder and prevents the piston from moving within the cylinder when a compressive force is applied to the lift platform and an unlocked position, and
a touch pad for actuating the locking mechanism between the locked position and the unlocked position;
wherein the gas spring includes: a cylinder with a bore, a piston mounted within the bore, a rod coupled to the piston that extends out of the cylinder and the locking mechanism has a locked position that prevents movement of the piston within the bore and an unlocked position that allows movement of the piston within the bore.

2. The lift stand of claim 1 wherein the locking mechanism comprises a hydraulic fluid and a valve that controls the flow of the hydraulic fluid within the cylinder.

3. The lift stand of claim 1 wherein the gas spring includes hydraulic fluid, gas and a separating piston for separating the hydraulic fluid from the gas within the cylinder.

4. The lift stand of claim 1 wherein the base includes a plurality of legs that extend outward in a radial pattern and the touch pad is coupled to an outer end of one of the legs.

5. The lift stand of claim 1 wherein the gas spring comprises a filling valve that allows gas to be added or removed from the cylinder.

6. The lift stand of claim 1 further comprising:
a hinge coupled to the touch pad; and
an actuator bar mounted to the base and coupled to the touch pad and the locking mechanism.

7. The lift stand of claim 1 further comprising:
a second touch pad coupled to an outer end of one of the plurality of legs for actuating the locking mechanism.

8. The lift stand of claim 1 wherein the lift platform includes a planar surface.

9. The lift stand of claim 1 wherein the lift platform includes fastening holes for securing the motorcycle to the lift platform.

10. The lift stand of claim 1 further comprising:
a pad mounted on a top surface of the lift platform.

11. A lift stand comprising
a lift platform adapted for supporting a motorized vehicle;
a base that is placed on a surface for providing stability to the lift stand;
an adjustable column disposed between the lift platform and the base, the adjustable column having a gas spring that includes a piston that slides against an inner diameter of a cylinder and a locking mechanism that slides against the inner diameter of the cylinder having a locked position that prevents movement of the piston within the bore when a compressive force is applied to the lift platform and an unlocked position that allows movement of the piston within the bore, and
a touch pad for setting the locking mechanism to the locked position or the unlocked position;
wherein the gas spring has an expansion spring force that is less than the weight of the motorized vehicle.

12. The lift stand of claim 11 wherein the expansion spring force is approximately 50% to 90% of the weight of the motorized vehicle.

13. The lift stand of claim 11 wherein the expansion spring force is between about 100 lbs and 200 lbs.

14. The lift stand of claim 11 wherein the base has a plurality of legs that extend outward in a radial pattern and the touch pad is coupled to an outer end of one of the legs.

15. The lift stand of claim 11 wherein the gas spring comprises a filling valve that allows gas to be added or removed from the cylinder.

16. The lift stand of claim 11 wherein the locking mechanism comprises a hydraulic fluid and a valve within the cylinder that controls the flow of the hydraulic fluid.

17. The lift stand of claim 11 wherein the gas spring includes hydraulic fluid, gas and a separating piston for separating the hydraulic fluid from the gas within the cylinder.

18. The lift stand of claim 14 wherein the locking mechanism comprises a coupling that extends from the outer end of the leg to the adjustable column.

19. The lift stand of claim 11 wherein the gas spring comprises a filling valve that allows gas to be added or removed from the cylinder.

20. The lift stand of claim 11 wherein the lift platform includes fastening holes for securing the motorcycle to the lift platform.
